(19) United States
(12) Patent Application Publication
(10) Pub. No.: US 2022/0260211 A1
(43) Pub. Date: Aug. 18, 2022

(54) DEVICE FOR RECOVERING THE REFRIGERATION UNITS OF LNG USED AS FUEL IN VEHICLES

(71) Applicant: ESAMETAL S.R.L., COLOGNA VENETA(VR) (IT)

(72) Inventors: Alberto CASTAGNARO, COLOGNA VENETA (VR) (IT); Giovanni COLOMBO, COLOGNA VENETA (VR) (IT)

(21) Appl. No.: 17/629,345

(22) PCT Filed: Jul. 24, 2019
(86) PCT No.: PCT/IB2019/056310

§ 371 Date: Jan. 21, 2022

(51) Int. Cl. F17C 9/04

(52) U.S. Cl. CPC F17C 9/04; F17C 2227/0327; F17C 2221/033

(57) ABSTRACT

A device for recovering the refrigeration units of LNG (liquid natural gas) used as fuel in vehicles is disclosed. The device can include: a first heat exchanger placed on a tractor of the vehicle between a LNG tank and a LNG gasification and heating circuit, said LNG being sent to a motor of the vehicle; a second heat exchanger placed inside a refrigerated cabin of a trailer or semi-trailer of the vehicle; and a closed intermediate circuit, in which a heat transfer fluid flows, which includes an apparatus for moving the heat transfer fluid, systems for connecting and disconnecting the pipelines of the intermediate circuit which are installed on the tractor with/from the pipelines of the same intermediate circuit installed on the trailer or semi-trailer and apparatus for storing and re-integrating the heat transfer fluid in the intermediate circuit and for maintaining the heat transfer fluid at a certain pressure value in said intermediate circuit.

### CROSS-REFERENCE TO RELATED APPLICATIONS

This application is the U.S. National Phase under 35. U.S.C. § 371 of International Application PCT/IB2019/055631, filed Jul. 24, 2019. The disclosures of the above described applications are hereby incorporated by reference in their entirety and made a part of this specification.

### SUMMARY

The present invention generally refers to a device for recovering the refrigeration units of the liquid natural gas (LNG) used as fuel in vehicles. More particularly, the invention relates to a new technology for an efficient and safe use and recovery of refrigeration units available on vehicles which use natural gas as fuel, when the natural gas is available and stored as a cryogenic liquid (LNG) on board of said vehicles.

The invention mainly concerns the field of refrigerated vehicles, in case the LNG-powered tractors are used for towing refrigerated trailers, even if the use is not limited to road transport, but it can also be extended to LNG-supplied air, naval and rail vehicles, when a cold production is required for refrigeration and/or air conditioning.

In the following description, the term “heat transfer fluid” means a fluid (liquid or gas) with chemical-physical characteristics (in particular high thermal capacity and thermal conductivity) which are suitable for transmitting thermal energy at low temperatures, i.e. temperatures typical of LNG. An example of a gaseous heat transfer fluid suitable for the purposes of the present invention is helium, while an example of a suitable liquid heat transfer fluid is glycol, possibly mixed with water or other liquids in suitable concentrations.

Furthermore, the term “refrigeration units” refers to the quantity of the thermal energy that the LNG or the heat transfer fluid is able to subtract by evaporation (latent refrigeration units) and/or by heating (sensitive refrigeration units), the term “natural gas” means a colorless, non-corrosive and non-toxic gaseous mixture, composed mainly of methane and possibly containing small amounts of ethane, propane, nitrogen and other components, while the term “liquid natural gas or LNG” means natural gas in a cryogenic liquid state which, when saturated and at atmospheric pressure, corresponds to a temperature of about −160° C. Furthermore, the term “liquid carbon dioxide or LCO2” means carbon dioxide in a cryogenic liquid state which, when saturated and at a pressure of about 5 atm., corresponds to a temperature of about −57° C. and the term “liquid nitrogen or LIN” means nitrogen in a cryogenic liquid state which, when saturated and at atmospheric pressure, corresponds to a temperature of about −196° C.

Finally, the term “standard refrigerator system” means any system currently in use for producing refrigeration units, such as compression or absorption refrigeration machines, which differ one from each other in relation to the type of energy used for making the cooling (mechanical energy if a compression cycle is used and thermal energy if an absorption cycle is used), and heat exchangers in which a cryogenic fluid, for example LIN or LCO2, gives refrigeration units to the environment to be cooled or to auxiliary heat transfer fluids. In particular, compression refrigeration systems (said refrigeration systems are powered directly by the tractor motor or by diesel or autonomous electrical motors) or LIN or LCO2 heat exchangers are generally used for vehicles.

In relation to vehicles powered by natural gas, a storage of said natural gas in its cryogenic liquid form (LNG) allows a remarkable increase in autonomy with respect to a storage performed in a gaseous form and the use of LNG is increasingly widespread, particularly for heavy vehicles. However, in order to be used in internal combustion motors, the LNG must be gasified and heated and this process is now performed by means of air or intermediate fluid vaporizers which absorb the heat, which is necessary for vaporizing and heating said LNG, from the air and/or from the vehicle's motor.

Therefore, if tractors fueled with natural gas stored in its cryogenic liquid form (LNG) are used for refrigerated vehicles, it would be energy-efficient not to dissipate the refrigeration units made available by the LNG, but to use them to remove part of the thermal energy from the refrigerated trailers that should otherwise be subtracted from the known refrigerator system.

The object of the present invention is therefore to provide a device for recovering the refrigeration units of the LNG used as fuel in vehicles, which allows to use the refrigeration units made available from LNG to maintain the desired thermal conditions in refrigerated trailers.

Another object of the present invention is to provide a device for recovering the refrigeration units of LNG used as fuel in vehicles, which allows to greatly reduce the energy required for refrigeration and, consequently, the emissions in the environment of pollutants and carbon dioxide (which is one of the main gases responsible of the greenhouse effect), as well as the total costs of a refrigerated transport.

A further object of the present invention is to provide a device for recovering the refrigeration units of LNG used as fuel in vehicles, which is particularly efficient, practical and safe.

These and other objects are achieved by a device for recovering the refrigeration units of LNG used as fuel in vehicles, according to the attached claim 1; other detailed technical characteristics of the device object of the invention are contained in the dependent claims. Advantageously, as natural gas is flammable, in order to safely recover the refrigeration units made available by LNG and to use said units for removing thermal energy from the refrigerated trailers, according to the present invention, an intermediate circuit with a heat transfer fluid is used, so as to minimize the risk of entering natural gas into the trailer in the case, however not very probable, of faults to pipes and/or to the equipment of the recovering device which is the object of the present invention. The heat transfer fluid can be a gaseous or a liquid substance.

If a gaseous heat transfer fluid, such as for example helium, is used, the device according to the invention comprises the following elements:
a first heat exchanger, placed on the tractor upstream the LNG gasification coil (already present on the tractor), for transferring the refrigeration units of LNG to the heat carrier fluid;
a second heat exchanger, placed inside the refrigerated cabin of the trailer or semi-trailer, for transferring the refrigeration units from the heat carrier fluid to the air inside the cabin;
a closed intermediate circuit in which a heat transfer fluid flows, wherein said intermediate circuit includes an equipment for moving the heat transfer fluid, a series of systems for a quick and lossless connection/disconnection of the intermediate circuit branches placed in the tractor with/from the intermediate circuit branches placed in the refrigerated trailer or semi-trailer, a storage tank for containing the heat transfer fluid able to re-integrate and to maintain the intermediate circuit at the operating pressure and insulated branches connecting the different elements of the intermediate circuit.

The recovery device according to the above mentioned first embodiment of the invention also comprises pressure and temperature meters, automatic and manual actuated valves, natural gas sensors in the intermediate circuit and/or in the refrigerated cabin of the trailer or semi-trailer of the vehicle and a centralized control and management system. Alternatively, if a fluid in a liquid state is used, a slight change in the system is used, which allows to prevent the freezing of the liquid thermal carrier fluid when its temperature, in the coldest points of the intermediate circuit, approaches the temperature of solidification of the fluid.

In particular, if a liquid heat transfer fluid, such as glycol or its mixtures with water or other liquids, is use, the recovery device according to the invention comprises:
a first heat exchanger, placed on the tractor upstream the LNG gasification coil already present on the tractor, for transferring the LNG refrigeration units to the heat carrier fluid;
a pipeline that allows the LNG to bypass the heat exchanger between the LNG and the heat carrier fluid when recovery of the refrigeration units of LNG is not required or when the temperature of the heat transfer fluid approaches, in the coldest points of the intermediate circuit, to the solidification temperature of the fluid;
a second heat exchanger, placed inside the refrigerated cabin, for transferring the refrigeration units from the heat transfer fluid to the air inside the cabin;
a closed intermediate circuit in which the heat transfer fluid flows, said circuit including an equipment for moving the heat transfer fluid, systems for a quick and lossless connection/disconnection of the intermediate circuit branches placed in the tractor with/from the branches placed in the refrigerated trailer or semi-trailer, a tank storage which contains the heat transfer fluid for its re-integration, a pump for re-integrating into the intermediate circuit the heat transfer fluid contained in the storage tank and an expansion vessel configured to contain the thermal expansions of the heat transfer fluid and avoid breakage in the intermediate circuit piping.

The recovery device according to the above mentioned embodiment of the invention also comprises insulated connection pipelines connecting the different elements of the intermediate circuit, pressure and temperature meters, automatic and manual actuated valves, natural gas sensors placed in the intermediate circuit and/or in the refrigerated cabin of the trailer or semi-trailer of the vehicle and a centralized control and management system.

### BRIEF DESCRIPTION OF THE DRAWINGS

Further objects and advantages of the present invention will become more clear from the following description, relating to preferred embodiments of the device for recovering the refrigerated units of the liquid natural gas (LNG) used as fuel in vehicles, according to the present invention, and from the attached drawings, in which:

FIG. 1 shows a block diagram of the device for recovering the refrigerated units of LNG, according to a first embodiment of the present invention;

FIG. 2 shows a block diagram of the device for recovering the refrigerated units of LNG, according to another embodiment of the invention with respect to the embodiment shown in FIG. 1.

### DETAILED DESCRIPTION

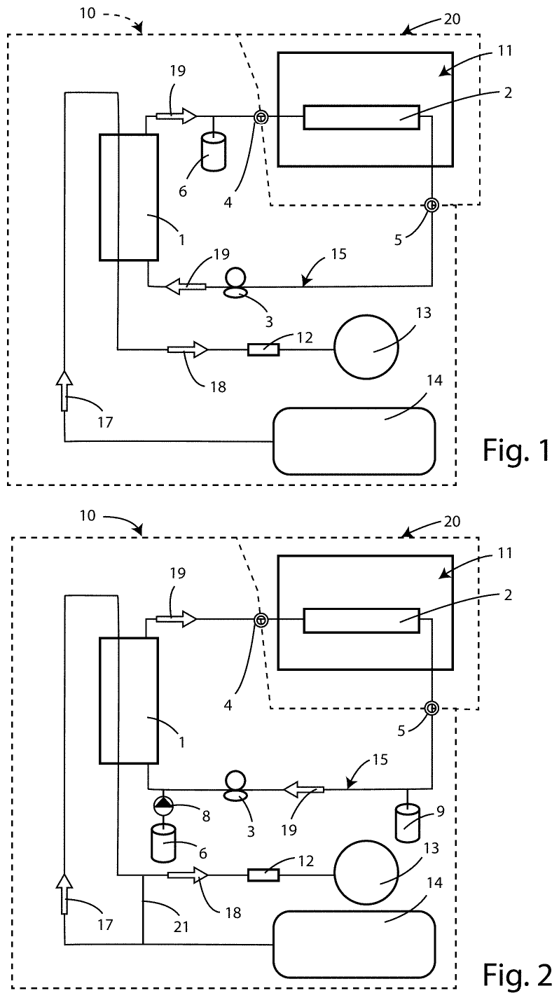

With particular reference to the attached FIG. 1, which shows a recovery device, according to the present invention, which uses a gaseous heat transfer fluid, such as, for example, helium, 1 indicates a natural gas/heat transfer fluid heat exchanger, placed in the tractor 10 of a vehicle downstream the LNG tank 14 and upstream the gasification coil 12 that is connected to the motor 13 of the tractor 10, 2 indicates a heat carrier fluid/air heat exchanger, placed inside the refrigerated cabin 11 of the trailer or semi-trailer 20 of said vehicle, 3 indicates an apparatus for moving the thermal carrier fluid along the intermediate circuit 15 (arrows 19 of FIG. 1), 4 and 5 indicate the quick and lossless connection/disconnection systems for connecting/disconnecting the pipelines of the intermediate circuit 15 installed in the tractor 10 with/from the connection pipelines of the intermediate circuit 15 placed in the trailer or semi-trailer 20, while 6 indicates a storage tank containing the heat transfer fluid for re-integrating said heat transfer fluid and for maintaining the intermediate circuit 15 at the operating pressure.

When the motor 13 of the tractor 10 operates, the quantity of LNG necessary for supplying said motor 13 is taken (arrow 17 of FIG. 1) from the cryogenic storage tank 14 and sent to the heat exchanger 1, in which the LNG evaporates and heats up by subtracting the necessary heat from the heat transfer fluid; the natural gas (LNG) (arrow 18 of FIG. 1) exiting the heat exchanger 1 is then sent to the vaporizer 12 which is normally used on tractors powered by LNG, and to the motor 13. The vaporizer 12 ensures the correct functioning of the vehicle even when the tractor 10 is not connected to a trailer or semi-trailer 20 or when the recovery of the LNG refrigeration units is not required and the apparatus 3 for moving the heat transfer fluid is stationary. The heat transfer fluid, when crossing the heat exchanger 1, is cooled to a lower temperature than the temperature to be kept inside the refrigerated cabin 11 of the trailer or semi-trailer 20 and is therefore able to transfer refrigeration units to said cabin 11 through the exchanger 2 The intermediate circuit 15 is equipped with fast connection/disconnection systems 4, 5 with automatic opening/closing, which allow both a disconnection in two points of the circuit 15 (when it is necessary to disconnect the tractor 10 from the trailer or semi-trailer 20) and a subsequent reconnection.

Moreover, the automatic opening/closing systems 4, 5 allow to avoid the emptying of the intermediate circuit 15 and therefore the loss of pressurization, when the disconnection takes place.

The maintenance of the desired pressure in the intermediate circuit 15, as well as the reintegration of the heat-carrying fluid when needed, are also ensured by the tank 6, where the heat-carrying fluid is stored at a higher pressure than the pressure present in the intermediate circuit 15.

The apparatus 3 allows the movement and circulation of the heat transfer fluid inside the intermediate circuit 15, thus guaranteeing a flow rate suitable for using the refrigeration provided by the LNG; said apparatus 3 is deactivated when the tractor 10 is not connected to a trailer or semi-trailer 20 or when the recovery of the LNG units is not required.

Finally, a centralized control system manages the activation/deactivation of the apparatus 3 and the integration of the whole device in a management and control logic of a standard refrigeration system, in order to guarantee the maintenance of the desired temperature conditions inside the refrigerated cabin 11 of the trailer or semi-trailer 20 and to use the standard refrigeration system only when the refrigeration units provided by the device object of the present invention are not enough.

With particular reference to the attached FIG. 2, which shows a recovery device, according to the present invention, which uses a liquid heat transfer fluid, such as, for example, glycol or its mixtures with water or other liquids, and where the elements also present in FIG. 1 are indicated with the same numbers, 1 indicates a natural gas/heat transfer fluid exchanger placed on the tractor 10 upstream the gasification coil of the LNG 12 already present on said tractor 10 for transferring the LNG refrigeration units to the heat transfer fluid, 2 indicates a heat transfer fluid/air exchanger, which is placed inside the refrigerated cabin 11 of the trailer or semi-trailer 20 of the vehicle for transferring the refrigeration units from the heat carrier fluid to the air inside the cabin 11, 21 indicates a by-pass pipe of the exchanger 1 which allows the LNG to bypass the heat exchanger 1 when the recovery of the LNG refrigeration units is not required or when the temperature of the heat transfer fluid in the coldest points of the intermediate circuit 15 approaches the solidification temperature, 3 indicates an apparatus for moving the heat transfer fluid, 4 and 5 indicate the fast and lossless connection/disconnection systems of the pipelines of said intermediate circuit 15 placed in the tractor 10 of the vehicle with/by the pipelines placed in the trailer or semitrailer 20, 6 indicates a storage tank for the heat transfer fluid, 8 indicates a pump for reintegrating the heat transfer fluid contained in the storage tank 6 in the intermediate circuit 15, while 9 indicates an expansion vessel used to contain the thermal expansions of the heat transfer fluid and avoid breakages in the pipelines of the intermediate circuit 15.

When the motor 13 of the tractor 10 operates and the by-pass pipe 21 is closed, the quantity of LNG necessary for supplying the motor 13 is taken from the cryogenic storage tank 14 and sent to the heat exchanger 1, in which the LNG evaporates and heats up by subtracting the necessary heat from the heat transfer fluid. The natural gas leaving the exchanger 1 is then sent to the vaporizer 12 normally used on tractors 10 supplied with LNG and to the motor 13. Said vaporizer 12 ensures the correct functioning of the vehicle even when the by-pass pipe is open.

The by-pass pipe 21 of the exchanger 1 can be opened in different situations and, in particular, when the tractor 10 is not connected to a trailer or semi-trailer 20, when the reduced need for refrigeration units of the refrigerated cabin 11 of the trailer or semi-trailer 20 causes the temperature inside the cabin 11 to drop below a threshold value and when the temperature of the heat transfer fluid at the outlet of the exchanger 1 is lowered up to a selected threshold value (which depends on the heat transfer fluid used) to avoid freezing of said heat transfer fluid.

When the by-pass pipe 21 is opened, the apparatus 3 for moving the heat transfer fluid is deactivated, while the LNG is sent to the regasification and heating coil 12 of the tractor 10 and then to the motor 13 through the same by-pass pipe 21.

On the other hand, when the by-pass pipe 21 is closed, the LNG passes through the exchanger 1 for transferring refrigeration units to the heat transfer fluid which cools to a lower temperature than the temperature to be kept inside the refrigerated cabin 11 of the trailer or semi-trailer 20 and is therefore able to transfer refrigeration units to said cabin 11 through the exchanger 2. The intermediate circuit 15 is equipped with fast connection/disconnection systems with automatic opening/closing, which allow both a disconnection in two points of the circuit 15 when it is necessary to detach the tractor 10 from the trailer or semi-trailer 20 and a subsequent reconnection.

The automatic opening/closing systems 4, 5 also allow to avoid the loss of heat transfer fluid when the disconnection occurs. The maintenance of the desired pressure in the intermediate circuit 15, as well as the reintegration of the heat transfer fluid when needed, are ensured by the pump 8 which takes the liquid to be reintegrated from the tank 6.

The apparatus 3 allows the movement and circulation of the heat transfer fluid inside the intermediate circuit 15, thus guaranteeing a flow rate suitable for using the refrigeration units provided by the LNG.

Finally, a centralized control system manages the activation/deactivation of the elements and, in particular, the opening/closing of the valves on the by-pass pipe 21 and the activation/deactivation of the apparatus 3 for moving the heat transfer fluid, as well as the integration of the whole device in a management and control logic of the standard refrigeration system of the vehicle, in order to guarantee the maintenance of the desired temperature conditions inside the refrigerated cabin 11 of the trailer or semi-trailer 20 and to limit the use of the standard refrigeration system only when the refrigeration units provided by the device according to the present invention are not enough.

In brief, the invention allows the use of the LNG refrigeration units, which otherwise would be dissipated in the environment, when the LNG is used as fuel in vehicles with refrigerating apparatus, thus allowing a relevant fuel saving and a relevant reduction of atmospheric emissions of pollutants and carbon dioxide.

In numerical terms, the following embodiment allows to fully understand the advantages of the invention.

In fact, taking into consideration a semi-trailer for refrigerated conveyances at −20° C., with a refrigerated cabin of a length of 12 meters and a height and width equal to 2.5 meters (which is equivalent to an exchange surface of 132.5 m²), assuming that the coefficient of the thermal transmission of said cabin is equal to 0.4 W/m²K (a maximum value indicated by the ATP standard (Accord Transport Perissable) for a reinforced isothermal vehicle, suitable for a conveyance at −20° C.) and considering an external temperature of 30° C., the cooling capacity necessary to maintain the temperature of −20° C. inside the semi-trailer is equal to 2.65 kW.

The following table shows, at different speeds of the vehicle, the refrigeration units (latent and sensitive) that the LNG used for traction makes available.

| Speed | GNL consumption | Available cooling | Requirement |
|---|---|---|---|
| (km/h) | (Kg/h) | capacity (kW) | coverage (%) |
| 10 | 3.3 | 0.6 | 24.1 |
| 20 | 6.7 | 1.3 | 48.2 |
| 30 | 10.0 | 1.9 | 72.3 |
| 40 | 13.3 | 2.6 | 96.4 |
| 50 | 16.7 | 3.2 | 120.5 |
| 60 | 20.0 | 3.8 | 144.7 |
| 70 | 23.3 | 4.5 | 168.8 |
| 80 | 26.7 | 5.1 | 192.9 |

The following data has been considered in the table:
LNG latent evaporation heat equal to 510 kJ/Kg;
LNG specific heat equal to 1.8 kJ/KgK;
LNG temperature difference equal to 100° C.;
mileage per each Kg of LNG equal to 3 Km/Kg.

Moreover, “requirement coverage” means the cooling capacity required to maintain a temperature inside the refrigerated cabin of −20° C., with an external temperature of 30° C., with the following assumptions:
k wall=0.4 W/m²K;
dimensions of the refrigerated cabin: 12 m×2.5 m×2.5 m;
absence of heat increase due to the shipped products.

Therefore, as shown in the aforementioned table, in the absence of an increase in the heat due to the shipped products, with a vehicle speed of about 40 Km/h, the refrigeration units made available by the LNG allow the maintenance of the desired temperature (−20° C.) inside the refrigerated cabin, without the aid of a standard refrigeration system.

From the above description, the features of the device for recovering the refrigeration units of the liquid natural gas (LNG) used as fuel in vehicles, which is the object of the present invention, are clear, as well as the related advantages.

Finally, it is clear that numerous other variants can be applied to the present device, without departing from the novelty principles inherent in the inventive idea, as it is clear that, in the practical implementation of the invention, materials, shapes and dimensions of the details may be any according to requirements and the same may be replaced with other equivalents.

1. A device for recovering refrigeration units of LNG (liquid natural gas) used as fuel in vehicles, said device configured for being installed in said vehicles comprising a tractor and a trailer or semi-trailer with a refrigerated cabin, said device comprising:
a first heat exchanger, configured to be placed on said tractor between a LNG tank and a LNG gasification circuit, said LNG being sent to a motor configured to drive said tractor, said first heat exchanger being configured to transfer the refrigeration units of the LNG to a heat transfer fluid, so as to use said refrigeration units in order to remove thermal energy from said refrigerated cabin configured to be installed on the trailer or semi-trailer,
a second heat exchanger, placed inside said refrigerated cabin configured to be installed on the trailer or semi-trailer, which is configured to transfer the refrigeration units from said heat transfer fluid to the air inside said refrigerated cabin;
a closed intermediate circuit, in which said heat transfer fluid flows, which includes an apparatus for moving said heat transfer fluid, systems for fast connecting and disconnecting, without leakages, pipes of said intermediate circuit configured to be installed on said tractor from the pipes of said intermediate circuit installed on said trailer or semi-trailer; and
a tank for storing the heat transfer fluid, said heat transfer fluid being a gas or a liquid,
wherein the tank is configured for recovering said heat transfer fluid and for maintaining the intermediate circuit at a certain operating pressure value.

2. Recovery device according to claim 1, wherein the LNG flowing at the output of said first heat exchanger is sent to a vaporizer and to said motor configured to drive said tractor.

3. Recovery device according to claim 1, wherein said heat transfer fluid, passing through said first heat exchanger, cools at a lower temperature than the temperature existing inside the refrigerated cabin configured to be installed on the trailer or semi-trailer and is therefore capable of yielding refrigeration units to said refrigerated cabin through said second heat exchanger.

4. Recovery device according to claim 1, wherein said tank, in which said heat transfer fluid is stored, is placed at a pressure value higher than the pressure value existing in said intermediate circuit.

5. Recovery device according to claim 1, wherein a centralized control system manages activation or deactivation of said apparatus for moving said heat transfer fluid and manages integration of the device for recovering the refrigeration units of said LNG for controlling a standard refrigerating system configured to be installed on the vehicle, thus ensuring maintenance of desired temperature conditions inside said refrigerated cabin of the trailer or semi-trailer.

6. Recovery device according to claim 1, wherein said device comprises a by-pass pipe which allows LNG to flow directly from said LNG tank to said gasification circuit, without passing inside said first heat exchanger when a recovery of refrigeration units of said LNG is not required or when temperature of said heat transfer fluid approaches, at certain points of said intermediate circuit, a solidification temperature of said fluid.

7. Recovery device according to claim 1, wherein said tank is connected to a pump able to carry out a recovery of said heat transfer fluid into said intermediate circuit.

8. Recovery device according to claim 1, further comprising an expansion vessel is connected to said intermediate circuit, said vessel being configured to contain thermal expansions of the heat transfer fluid and to avoid breakage in the pipes of said intermediate circuit.

9. Recovery device according to claim 1, further comprising a centralized control system manages activation or deactivation of said apparatus for moving said heat transfer fluid, opening and closing of valves of a by-pass pipe and integration of the whole device for recovering the refrigeration units of LNG for controlling a standard refrigerated system configured to be installed on the vehicle, thus ensuring maintenance of conditions of a desired temperature inside the refrigerated cabin configured to be installed on the trailer or semi-trailer.

10. Recovery device according to claim 1, wherein the said heat transfer fluid is the gas.

11. Recovery device according to claim 10, wherein the gas is helium.

12. Recovery device according to claim 1, wherein the said heat transfer fluid is the liquid.

13. Recovery device according to claim 12, wherein the liquid is glycol or mixtures of glycol with water or other liquids.
